(19) United States
(12) Patent Application Publication
(10) Pub. No.: US 2003/0194889 A1
(43) Pub. Date: Oct. 16, 2003

(54) Right angle board to board power connector

(75) Inventors: Jill M. Golat, Boulder, CO (US); Brian J. Stanczyk, Rochester, MN (US)

Correspondence Address: IBM Corporation, Intellectual Property Law, Dept. 917, 3605 Hwy. 52 North, Rochester, MN, 55901, US

(73) Assignee: INTERNATIONAL BUSINESS MACHINES CORPORATION, Armonk, NY

(21) Appl. No.: 10/120,878

(22) Filed: Apr. 11, 2002

(51) Int. Cl. H01R 12/00

(52) U.S. Cl. 439/79

(57) ABSTRACT

An electrical connector for connecting a first electrical component to a second electrical component includes a plurality of wires, each having a different electrical path length. Each wire has a transverse dimension for at least a portion of the wire chosen so that the wire has a resistance within a preselected range that is common to each of the plurality of wires.

### BACKGROUND OF THE INVENTION

1. Field of the Invention

The present invention relates to electrical connectors and, more specifically, to an electrical connector that maintains a common resistance in each wire of a plurality of wires having different electrical path lengths.

2. Description of the Prior Art

As shown in FIG. 1, a prior art electronic connector that connects a first electrical component 10 to a second electrical component 12 may include a plurality of wires 14 that follows a non-linear path, such as a right-angled path. In such a case the inner wires follow a shorter overall path that the longer wires do. In prior art connectors, the dimensions (i.e. thickness and width) of the wires that are transverse to the path of the wires are the same. When the transverse dimensions of the wires are the same, the wires following a longer path have a greater total linear resistance than the wires following a shorter path.

This difference in resistance between the wires causes a DC power drop and current load across the wires. The longer paths have a higher resistance and therefore have a larger voltage drop across them. Also, current tends to take the path of least resistance so the shorter wires would see more current across them, and thus have a higher temperature rise. Furthermore, this difference in resistance can introduce adverse transmission line effects, which may become pronounced with high speed communications applications.

Therefore, there is a need for an electrical connector that compensates for differing total resistance of different wires used to connect electrical components.

### SUMMARY OF THE INVENTION

The disadvantages of the prior art are overcome by the present invention which, in one aspect, is an electrical connector for connecting a first electrical component to a second electrical component. The connector includes a plurality of wires, each having a different electrical path length. Each wire has a transverse dimension for at least a portion of the wire chosen so that the wire has a resistance within a preselected range that is common to each of the plurality of wires.

In another aspect, the invention is an electrical connector for connecting a first circuit board to a spaced-apart second circuit board in which a non-linear electrical path is followed between the first circuit board and the second circuit board. The electrical connector includes at least one first wire having a first width and a first resistence and at least one second wire having a second width, different from the first width, and a second resistence. The second width is chosen so that the second resistance is within a predetermined range of the first resistance.

In yet another aspect, the invention is a method of designing an electrical connector, including a plurality of wires that connect a first electrical component to a second electrical component. A desired common resistance range is selected for each of the plurality of wires. An electrical path length for each of the plurality of wires is determined. A transverse dimension is selected for each of the plurality of wires so that the electrical path length and width for each wire causes the wire to have a resistance within the desired common resistance range.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a top plan view of a prior art device.

FIG. 2 is a top plan view of a device according to a first embodiment of the invention.

FIG. 3 is a is a top plan view of a device according to a second embodiment of the invention.

FIG. 4A is a side elevational view of a third embodiment of the invention.

FIG. 4B is a cross-sectional view of the embodiment shown in FIG. 4A, taken along line 4B-4B.

FIG. 5 is an side elevational view of a fourth embodiment of the invention.

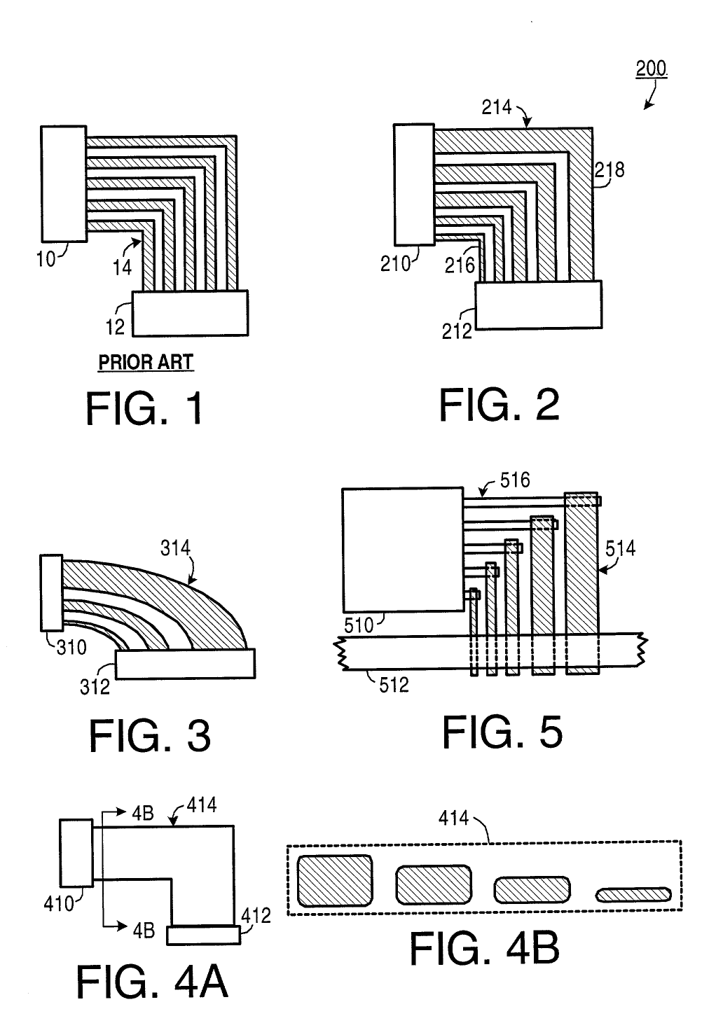

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

In one illustrative embodiment 200 of the invention, as shown in FIG. 2, a first electrical component 210, such as a first circuit board, is electrically connected to a second electrical component 212, such as a second circuit board, via a plurality of wires 214. Because the first electrical component 210 is disposed at an angle to the second electrical component 212, the innermost wire 216 has a shorter electrical path length than the outermost wire 218. To compensate for the increased linear resistance accruing in the plurality of wires 214 as the electrical path length increases from innermost wire 216 to outermost wire 218, the widths of the wires also increases from innermost wire 216 to outermost wire 218. The widths are chosen so that the total resistance of each of the plurality of wires 214 falls within a predetermined range, or is substantially the same, depending on the required tolerance for the overall circuit.

As shown in FIG. 3, the plurality of wires 314 connecting the first electrical component 310 to the second electrical component 312 do not have to follow an angular path, but could follow a curved path, or even a multidirectional path, so long as a transverse dimension, such as wire width or wire thickness (or both) of each of the wires 314 is chosen so that the total linear resistance of each of the wires 314 falls within the desired predetermined range.

While FIGS. 2 and 3 show that the transverse dimension that is adjusted to compensate for linear resistance is wire width, FIGS. 4A and 4B demonstrate that varying the wire thickness of the wires 414 can be used to adjust the linear resistance of each wire connecting the first electrical element 410 to the second electrical element 412.

As shown in FIG. 5, many electrical components 510 include a plurality of wires 516 that have a common thickness. However, these components 510 can be coupled to a second component 512 by using a plurality of coupling wires 514 having varying thicknesses to compensate for total linear resistance.

To design a connector according to the invention, the designer first selects a desired common resistance range for each of the plurality of wires. This can be based on several factors, such as the requirements of the load, transmission line effects limitations for the circuit and other factors affecting total impedance. The electrical path length for each of the plurality of wires is determined by laying out the circuit. Then the transverse dimensions (wire width and thickness) for each of the plurality of wires is selected so that the electrical path length and width for each wire causes the wire to have a resistance within the desired common resistance range.

In some applications, there may be a need to have wires of different composition, with each composition having a different resistance. In such a case, the designer could also take into account the inherent resistance of each wire due to its composition.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. An electrical connector for connecting a first electrical component to a second electrical component, the connector comprising a plurality of wires, each wire having a different electrical path length, each wire having a transverse dimension for at least a portion of the wire chosen so that the wire has a resistance within a preselected range that is common to each of the plurality of wires.

2. The electrical connector of claim 1, wherein the transverse dimension comprises wire width.

3. The electrical connector of claim 1, wherein the transverse dimension comprises wire thickness.

4. The electrical connector of claim 1, wherein each of the plurality of wires follows an angular path.

5. The electrical connector of claim 4, wherein the angular path follows a right angle.

6. An electrical connector for connecting a first circuit board to a spaced-apart second circuit board in which a non-linear electrical path is followed between the first circuit board and the second circuit board, the electrical connector comprising:
a. at least one first wire having a first width and a first resistence; and
b. at least one second wire having a second width, different from the first width, and a second resistence, the second width chosen so that the second resistance is within a predetermined range of the first resistance.

7. The electrical connector of claim 6, wherein the non-linear electrical path is an angular path.

8. The electrical connector of claim 6, wherein the non-linear electrical path is a right-angle path.

9. A method of designing an electrical connector, including a plurality of wires that connect a first electrical component to a second electrical component, comprising the steps of:
a. selecting a desired common resistance range for each of the plurality of wires,
b. determining an electrical path length for each of the plurality of wires; and
c. selecting a transverse dimension for each of the plurality of wires so that the electrical path length and width for each wire causes the wire to have a resistance within the desired common resistance range.

10. The method of claim 9, wherein the selecting a transverse dimension step comprises the step of selecting a width of the wire.

11. The method of claim 9, wherein the selecting a transverse dimension step comprises the step of selecting a thickness of the wire.
